(19) United States
(12) Patent Application Publication
(10) Pub. No.: US 2025/0346214 A1
(43) Pub. Date: Nov. 13, 2025

(54) WHEEL STOP DEVICE AND METHOD OF USE

(71) Applicant: Kristen J. Rock Chouinard, Leawood, KS (US)

(72) Inventor: Kristen J. Rock Chouinard, Leawood, KS (US)

(21) Appl. No.: 19/207,014

(22) Filed: May 13, 2025

Related U.S. Application Data
(60) Provisional application No. 63/646,248, filed on May 13, 2024.

(51) Int. Cl. B60T 3/00; B62B 3/14; B62B 5/04

(52) U.S. Cl. CPC B60T 3/00; B62B 3/1404; B62B 5/049

(57) ABSTRACT

A wheel stop device and method for using same is provided. The wheel stop device includes a base connected to a track having a ramp section, peak, and valley section. Further aspects include an upright member with a handle and a foot extension configured to grip a user's foot for holding the wheel stop device steady. The wheel stop device can hold a wheel of a shopping cart or other wheeled object stationary by placing the wheel stop device on the ground, rolling the cart wheel onto the track ramp section, over the peak, and into the valley section, where the engaged wheel will remain stationary until a user pushes and/or pulls it back up the valley section over the peak and off the ramp. The wheel stop device eliminates the risk of a wheeled cart rolling away while a user unloads the cart.

### CROSS-REFERENCE TO RELATED APPLICATIONS

This application claims priority pursuant to 35 U.S.C. 119 (e) to co-pending U.S. Provisional Patent Application Ser. No. 63/646,248, filed May 13, 2024, the entire disclosure of which is incorporated herein by reference.

### FIELD OF THE INVENTION

The present invention relates generally to stoppers and locks for wheeled objects. More specifically, the present invention is concerned with a wheel stop device and method for maintaining a shopping cart in a stationary position.

### BACKGROUND

The vast majority of grocery stores and many other retail establishments provide shopping carts for customers to use while shopping in their stores and loading purchased items into vehicles in the parking lot. A standard shopping cart typically includes one or more open basket configured to receive and hold items a customer places therein, the basket connected to a steering handle and mounted on wheels. The wheels of a standard shopping cart include two front, rotating, caster wheels and two rear wheels in a fixed front and back position, allowing a customer to easily maneuver the cart. Nevertheless, standard shopping carts do not include locks or stoppers on any of the shopping cart wheels.

The lack of locks or stoppers can create an issue for customers in keeping a cart stationary, particularly when unloading a cart full of items into the customer's vehicle. Parking lots at retail establishments such as grocery stores, big-box retailers, and hardware stores can be chaotic. There are several factors that often amplify the problem, including uneven parking lot surfaces, a customer having one or more children present, a customer utilizing a heavier than standard shopping cart-such as those made to look like a racecar for children or larger carts commonly utilized at membership warehouse stores or hardware stores-inclement weather, and uneven weight distribution of grocery items, to name a few. A shopping cart not staying stationary while unloading is a recurring problem that caregivers of young children, the aging population, and the disabled community, among others, encounter on a very regular basis. Accordingly, it would be beneficial to have an easy to use device for stopping a shopping cart in place, giving consumers peace of mind when unloading a shopping cart.

Furthermore, there are similar issues with other wheeled objects without an effective lock or stopper mechanism. For example, it would be beneficial to have an effective wheel stop device for flatbed carts, scooters, wagons, bicycles, motorized vehicles, toys, and/or any other wheeled object which could utilize a wheel stop device for retaining the object in a stable and/or stationary position.

Heretofore there has not been available a wheel stop or method with the advantages and features of the present invention.

### SUMMARY OF THE INVENTION

The present invention comprises a wheel stop device and method of use. In an exemplary embodiment, the wheel stop device is configured for use with a shopping cart. In an exemplary embodiment, a user drives a shopping cart wheel onto the present wheel stop device, and the wheel stop device is configured to prevent the wheel with which it engages from spinning on the ground, holding the shopping cart in a stationary position.

In an exemplary embodiment, the wheel stop device of the present invention includes a track having a ramp section to a peak and an arched valley section. In an exemplary embodiment, the present device further includes an upright member connected to an end of the track valley section and positioned approximately perpendicular to the base of the wheel stop device. In an exemplary embodiment of the present invention, a user pulls or pushes a cart wheel onto the device ramp, up the ramp section peak, and down into the valley section of the track. In exemplary embodiments, the device retains the cart wheel within the valley section until a user pulls or pushes the cart wheel back up the valley section to the peak of the track. In an embodiment, the device upright member further serves to prevent a user from pushing or pulling the cart wheel too far, past the valley section. In an exemplary embodiment, the track ramp and arched valley further comprise upright wheel guards, which are configured to prevent lateral movement of an engaged cart wheel off of the device track.

In further embodiments, the device includes a handle positioned at the top of the upright member for added ease of use. In some embodiments, the height of the handle is adjustable. In some embodiments, the adjustability of the handle height is a function of the upright member having nested sections similar to a telescopic pole.

In further yet embodiments, the device includes a foot extension on an opposite side of the upright member from the track. In embodiments, the foot extension forms a pedal comprising grooves or other similar gripping surface configured for gripping a shoe of a user. In such embodiments, the extension provides added ease of use by allowing a user to hold the device in place with the user's foot while pulling or pushing a cart wheel onto and/or off of the device track.

In an exemplary embodiment, the wheel stop device of the present invention is easy to use for all consumers, including but not limited to caregivers of young children, the elderly, and disabled persons. In an embodiment, the combination of the ramp up, security provided by the guards on either side of the track, the valley or receiver where the cart wheel rests in place, and the handle feature make for an efficient, easy to use design and provide an excellent consumer experience.

In an exemplary embodiment, a consumer keeps a wheel stop device of the present invention in his or her vehicle for use at the time of unloading a shopping cart. In other embodiments, a retail store offers wheel stop devices of the present invention to consumers to borrow, either at the start of shopping with a shopping cart or on the way out to the parking lot.

Additionally, the present wheel stop device was designed to be both easy and fun to use with a clear mission of easing the stress and unnecessary burdens shoppers commonly experience today when unloading their purchases and/or cart passengers, such as children, into their vehicles. Furthermore, additional economic advantages include increased visits to retailers due to the enhanced experience with the present wheel stop device. Potential economic impact could also be seen by retail establishments, as collisions and accidents in their parking lots would decrease, and shopper visits to retail locations with reputationally adverse parking lot experiences might increase as a result of the reliability of the present invention.

An elderly or disabled person may not have the physical capacity to bend all the way to the ground, so the handle of the present wheel stop device is a solve for this. Moreover, the height of the wheel guards or rails and the track of the present device upon which the shopping cart wheel would sit provides added security. The shape of the arched ramp of the present wheel stop device allows persons of varying strength and ability to roll their shopping carts on and off the device with ease and peace of mind.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is an upper, front, perspective view of a wheel stop device embodying the present invention.

FIG. 2 is an upper, back, perspective view of the wheel stop device.

FIGS. 3-4 are side, elevational views of the wheel stop device.

FIG. 5 is a front, elevational view of the wheel stop device.

FIG. 6 is a back, elevational view of the wheel stop device.

FIG. 7 is a top, plan view of the wheel stop device.

FIG. 8 is a bottom, plan view of the wheel stop device.

FIG. 9 is an upper, front, angled, perspective view of the wheel stop device.

FIG. 10 is an environmental, perspective view of an embodiment of a wheel stop device of the present invention with a shopping cart loaded thereon.

FIG. 11 is an enlarged, environmental, perspective view of an embodiment of a wheel stop device of the present invention with a shopping cart wheel engaged with the wheel stop device.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises a wheel stop device for engagement with a wheel of a wheeled object or vehicle, such as but not limited to a wheel of a shopping cart, and methods of use thereof. In an exemplary embodiment, a wheel stop device of the present invention includes a base configured for placement on and engagement with a ground surface. In an exemplary embodiment, the base is connected to and/or mounts a track configured for engaging with, receiving, mounting, and/or retaining a wheel of a wheeled object. In an exemplary embodiment, the track includes a ramp portion and a valley portion, with a peak therebetween.

In an exemplary embodiment, the wheel stop device further comprises an upright member connected to a back end of the valley portion of the track. In embodiments, the upright member further attaches to a handle. In some embodiments, the wheel stop device does not include a handle, and in others, the device includes two handles. In further embodiments of the present invention, the wheel stop device does not include an upright member.

In embodiments, the wheel stop device further includes a foot extension configured for engagement with a user's foot to help hold the wheel stop device in place. In other embodiments, the wheel stop device does not include a foot extension.

In embodiments, the wheel stop device is made of one or more rigid materials, including but not limited to hard plastic(s), metal(s), polypropylene, polycarbonate, carbon fiber, wood, or any other rigid material now known or later developed which is suitable for bearing the weight of a wheel of a loaded wheeled object.

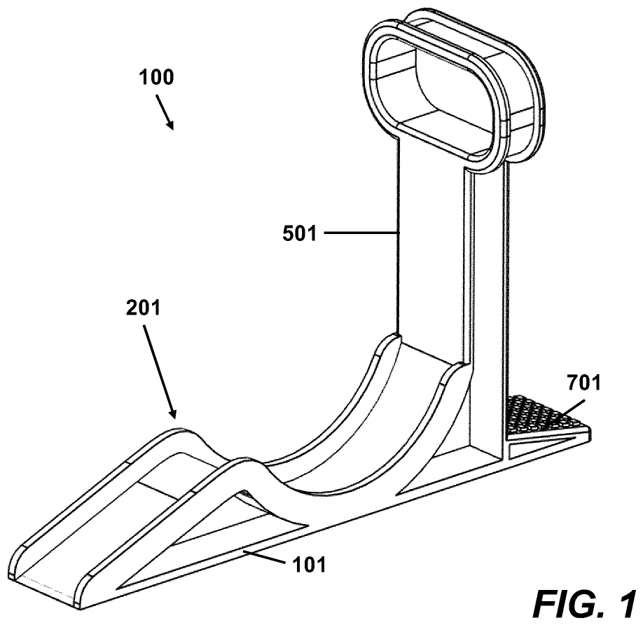

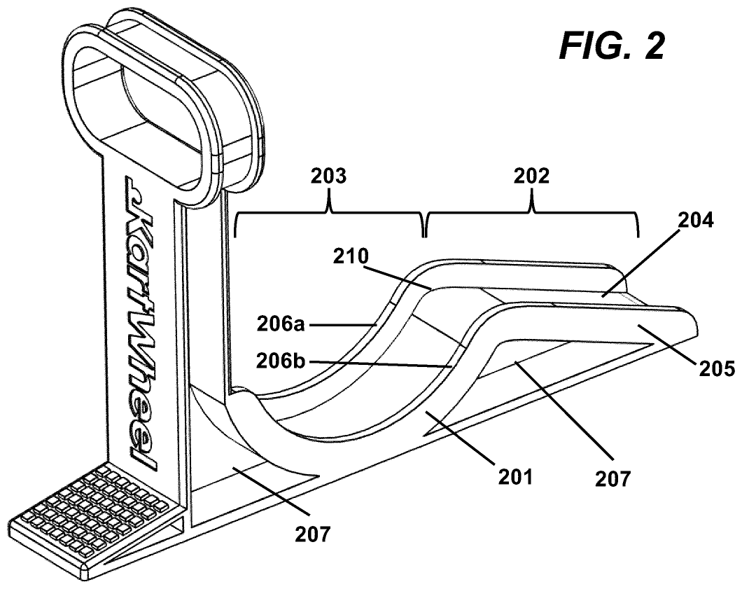

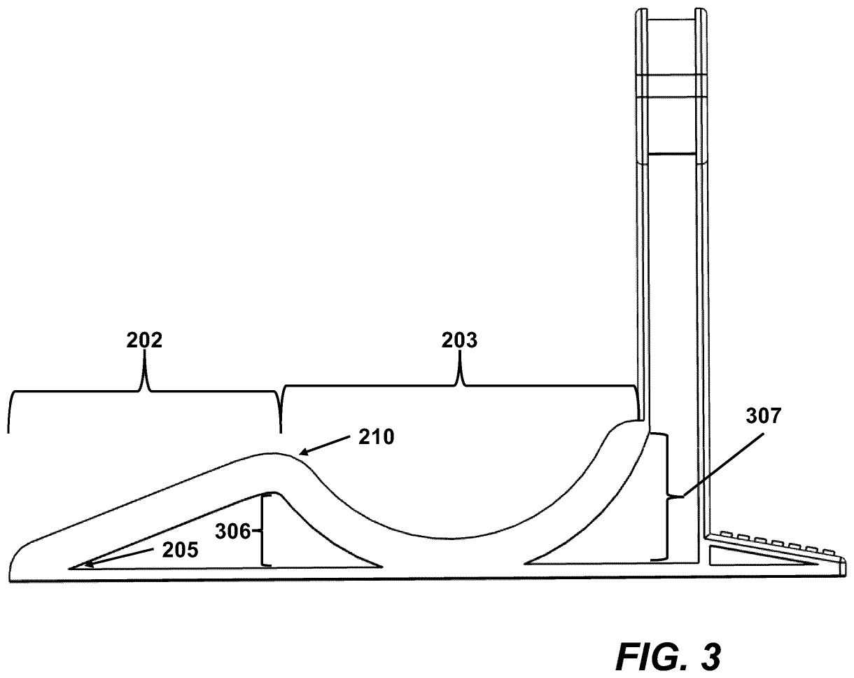

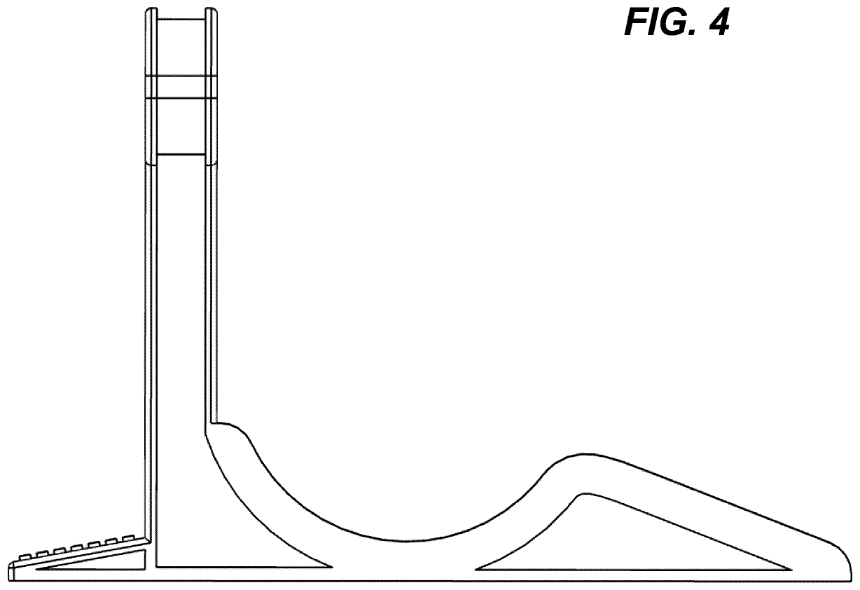

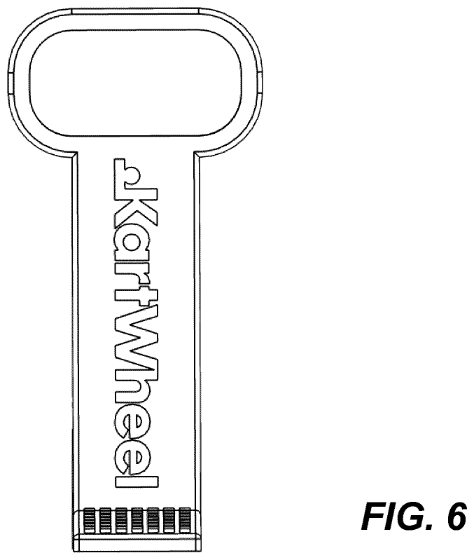

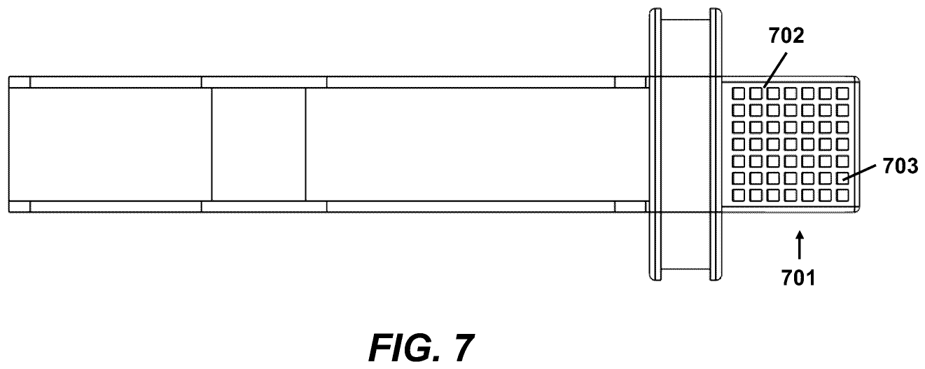

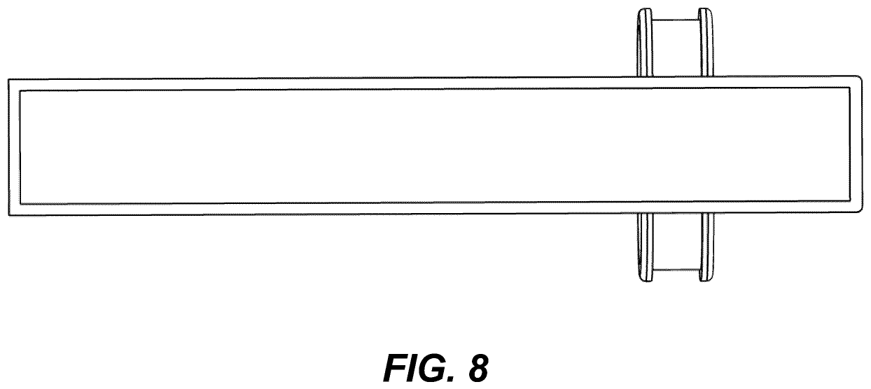

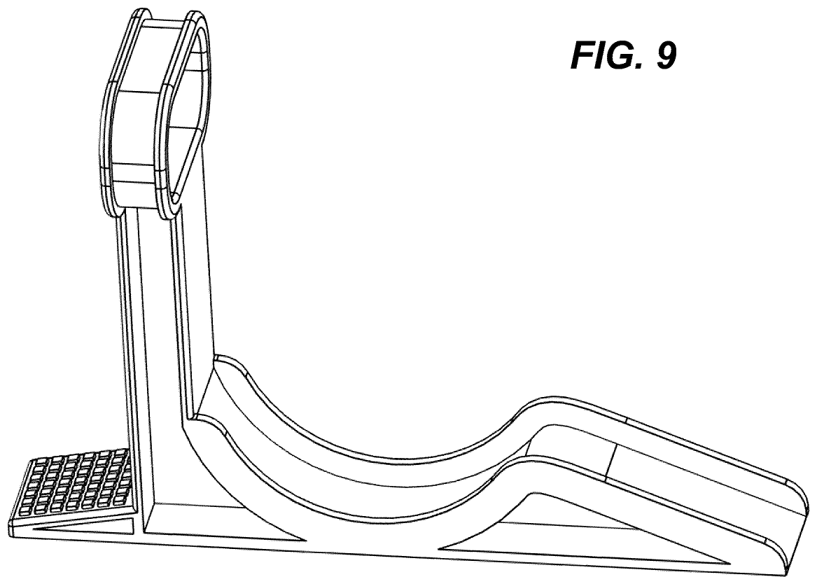

Referring now to the drawings in more detail, FIGS. 1-9 show an exemplary embodiment of a wheel stop device 100 of the present invention, which is further described herein. In the shown embodiment, the wheel stop device 100 of the present invention comprises a base 101 extending from a front end to a back end of the wheel stop device 100. The base 101 defines a bottom surface configured to be positioned on the ground by a user and an upper surface opposing said bottom surface.

In some embodiments, the bottom surface is made up of the same material as the rest or most of the wheel stop device. In other embodiments, the bottom surface of base further includes or is attached to a material configured to prevent movement of the wheel stop device when it is placed on the ground, such as but not limited to rubber, silicone, polyurethane, or other suitable non-slip material which creates a high degree of friction between the bottom surface and the ground to prevent unwanted movement of the wheel stop device when it is in use, as such materials are known in the art. In some embodiments, as shown in FIGS. 1-9, the base 101 bottom surface includes a substantially flat surface, the entirety or majority of which is configured to contact a ground surface. In alternative embodiments, the base bottom surface may include sections and/or feet which are configured for contacting a ground surface.

In the embodiment shown in FIGS. 1-9, the wheel stop device 100 further comprises a track 201 connected and/or coupled to the upper surface of the base 101 at the front end of the base; a foot extension piece 701 connected and/or coupled to the upper surface of the base 101 at the back end; and an upright member 501 connected and/or coupled to and extending upward approximately perpendicularly away from the upper surface of base 101, positioned between the track 201 and the foot extension 701. As described in greater detail below, the wheel stop device 100 is configured such that a user can place it on the ground and push/pull a wheel of a wheeled object, such as but not limited to a shopping cart, onto the track 201 of the wheel stop device 100, wherein the wheel stop device 100 will restrict any unwanted movement of the shopping cart until the user selectively removes the wheel from the wheel stop device 100.

Referring to FIGS. 1, 2, and 3, the track 201 defines a ramp section 202 located substantially near the front end of the wheel stop device 100 and a valley section 203, with a peak 210 between the ramp section 202 and the valley section 203. In the shown embodiment, the valley section 203 is located and extending between the peak 210 and the upright member 501. As will be described further below, the track 201 is configured such that a user can push/pull a wheel of a wheeled object, such as a shopping cart, onto the front end of the wheel stop device 100, up the ramp section 202, over the peak 210, and onto the valley section 203. When the wheel is within the valley section 203, the track 201 is configured to retain the wheel within the valley section 203 and/or restrict the motion of the wheel along the length of ramp 201 such that it remains within the valley section 203 until the user pushes/pulls the wheel back out of valley section 203, over the peak 210, down the ramp section 202, and off of the front end of the wheel stop device 100. As such, the track 201 is configured to retain the shopping cart in a stable, stationary position when the wheel is located in the valley section 203.

The track 201 comprises an engagement surface 204 which is configured to support the wheel as it rolls between the ramp section 202 and the valley section 203. On the ramp section 202, the engagement surface 204 is connected to the upper surface of base 101 at the front end and extends upwardly away from the upper surface of base 101 toward the peak 210 at a peak angle 205. At the peak 210, where the ramp section 202 meets the valley section 203, the engagement surface 204 is separated from the upper surface of base 101 by a peak height 306. In some embodiments, the track 201 is configured such that the peak angle 205 is a sufficient degree, and the peak height 306 is a sufficient length such that a user can easily push/pull the wheel of the wheeled object onto and out of the valley section even when the wheeled object is heavy and/or full of items, such as but not limited to a shopping cart full of groceries and/or consumer goods. In some embodiments, the track 201 is configured such that the peak height 306 is of a sufficient height to ensure that the wheel remains in a stable, stationary position on the valley section 203 unless it is pushed/pulled by a user. In some such embodiments in which the wheel stop device 100 is configured to be used with heavier shopping carts, the degree of the peak angle 205 and the peak height 306 may be lower that embodiments of the wheel stop device 100 which are configured to be used with standard and/or lighter shopping carts or other wheeled objects.

In the shown embodiment, in the valley section 203, the engagement surface 204 defines a concave contour down from the peak 210 to the upper surface of base 101 and then back up towards the upright member 501. The portion of the valley section 203 wherein the engagement surface 204 is at its relative lowest point is herein referred to as the valley. In some embodiments, at the valley, the engagement surface 204 does not meet the upper surface of base 101 but is instead separated from the upper surface of base 101 by a valley height. Where the engagement surface 204 meets the upright member 501 (referred to herein as the end point of engagement surface 204), the engagement surface 204 is separated from the upper surface by an end point height 307. The contour of the engagement surface 204 is sufficiently concave such that when the wheel is within the valley section 203, the wheel's motion will be restricted to be retained on the valley section 203 and substantially remain in the valley unless a user pushes/pulls the wheel out of the valley. In embodiments, the combination of the contour of the engagement member and the end point height 307 serve to prevent a user from pushing or pulling the wheel too far past the ramp valley when moving the wheel into the valley section 203. In some embodiments, the contour of the engagement surface in the valley section 203 is not concave, instead presenting a v-shaped valley section. In some embodiments, the end point height 307 is zero, thereby making the valley extend to the upright member 501. In some embodiments, the end point height 307 substantially corresponds with the peak height 306, thereby making the valley section 203 substantially symmetrical and the valley located substantially centrally within the length of the valley section 203.

In the shown embodiment, the track 201 further comprises wheel guards or rails 206a and 206b connected to and extending upwardly away from opposing sides of engagement surface 204, separated by an engagement surface width, thereby preventing an engaged wheel from moving laterally off of the engagement surface 204. The first and second wheel guards 206a, 206b extend above the engagement surface 204 to a guard height which, in some embodiments, is consistent along the length of the track 201. In other, not shown, embodiments, the guard height is not consistent throughout and is relatively greater in the valley section 203 to provide relatively greater restriction of the wheel's lateral movement within the valley section 203. The combination of the engagement surface 204 and the wheel guards 206a, 206b define a groove along the length of track 201 which allows a user to easily move the wheel into and out of the valley section 203 while mitigating the potential for user error.

In the shown embodiment, at all points wherein the engagement surface 204 of track 201 is separated from the upper surface of base 101, there is a support surface 207 which provides support to engagement surface 204 such that its contour remains substantially rigid under the weight of the wheeled object. In some embodiments, such as the one shown in FIGS. 1-9, the support surface 207 is located centrally along the engagement surface width which is where at least the majority of the weight from the wheel will be located while in the groove of track 201 during use of the wheel stop device 100. In other embodiments, the support surface 207 spans the width of the engagement surface, thereby providing support along the entire width of the engagement surface 204. In some embodiments of the wheel stop device 100, there is no support surface 207. In some embodiments, the engagement surface 204 is capable of supporting the weight from the wheel as a function of the engagement surface 204 being comprised of a sufficiently rigid material, such as but not limited to polypropylene, polycarbonate, high-density polyethylene (HDPE), other plastics, steel, other metals, wood, carbon fiber, or any other sufficiently rigid material now known or later developed.

In some embodiments, the engagement surface width is of a sufficient width such that the width of the groove of track 201 substantially corresponds with the width of a shopping cart wheel or wheel of an alternative object or vehicle to be received. In some embodiments, the radius of the concave contour of the engagement surface 204 in the valley section 203 is at least as large as the radius of a wheel of a wheeled object such that the wheel can be completely contained on or within the valley section 203. In other embodiments, both the engagement surface width and the radius of the concave contour of the engagement surface 204 in the valley section 203 are configured to correspond to a wheel smaller or larger than the wheel of a standard shopping cart.

Referring to FIGS. 1, 2, and 7, the foot extension 701 defines a pedal which extends angularly from the upper surface of base 101 at the back end of wheel stop device 100 to a back side of the upright member 501. The foot extension is configured to provide a surface for a user to apply a force both horizontally and vertically, in some embodiments using their foot, against the wheel stop device to hold it in place as the user pushes/pulls the wheel of a wheeled object onto and out of the valley section 203. To that end, the foot extension 701 defines a gripping surface 702 facing upwardly, substantially away from the wheel stop device 100 which is configured to help hold the user's foot in place as the force is applied to the wheel stop device 100. In some embodiments, an angular top surface of the foot extension provides for an ergonomic engagement with a user's foot. In alternative embodiments, the top surface of the foot extension is substantially parallel with the bottom surface of the base.

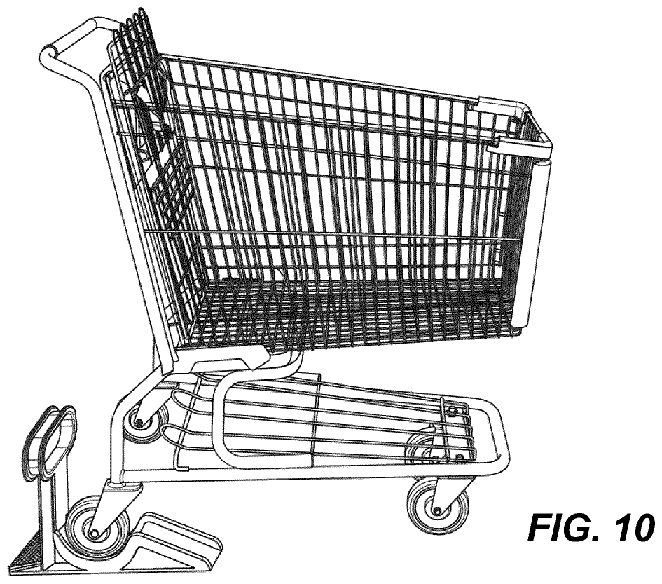

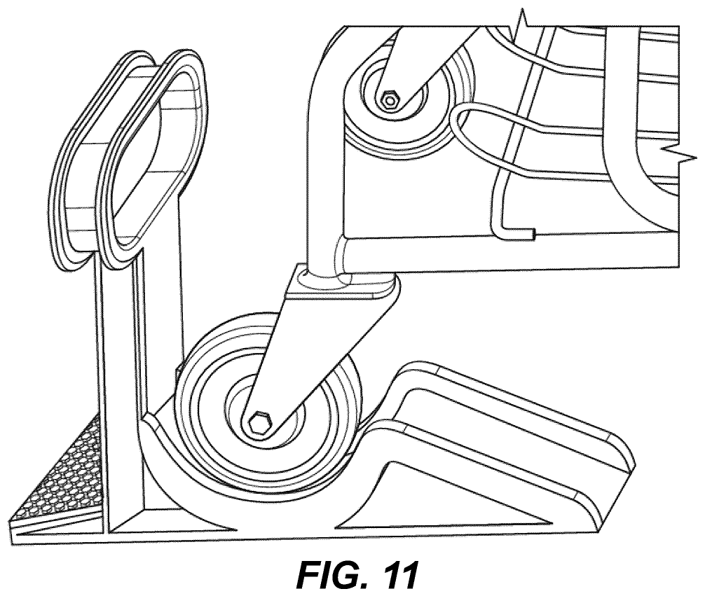

In some embodiments, such as those shown in FIGS. 1-11, the foot extension 701 comprises a plurality of gripping members 703 located on the gripping surface which prevent the user's foot, when engaged with the gripping surface, from moving in a direction substantially parallel to the gripping surface 702. In embodiments, as shown in FIGS. 1-9, the gripping members 703 each define a substantially rectangular or square prism shape with edges which grip onto the sole of a user's foot/shoe. In other embodiments, as shown in FIGS. 10-11, the gripping members 703 each define a substantially hexagonal prism shape with edges which grip onto the sole of a user's foot/shoe. In other, not-shown, embodiments, the gripping members are substantially cylindrical or a variety of other shapes which achieve the purpose of the invention as described herein. In still other embodiments, the gripping surface 702 defines grooves and/or other feature which grips the user's foot when it is engaged with the gripping surface 702 and prevents it from moving in a direction substantially parallel to the gripping surface 702, as such features are now known in the art or later developed. In further yet embodiments, the foot extension further integrates a gripping material, such as rubber, silicone, polyurethane, or other suitable non-slip material, as such features are now known in the art or later developed. In some embodiments, at all points where the foot extension 701 is separated from the upper surface of base member 101, there exists a support surface 207 extending therebetween similar to the support surface 207 described above. The support surface 207 provides support to the foot extension such that it can withstand the force applied to it by the user's foot during use of the wheel stop device 100. Although referred to herein as the foot extension 701, a user may apply a force to the extension via the user's hand or another object rather than a foot. Further yet, in some embodiments of the wheel stop device, a foot extension is not included.

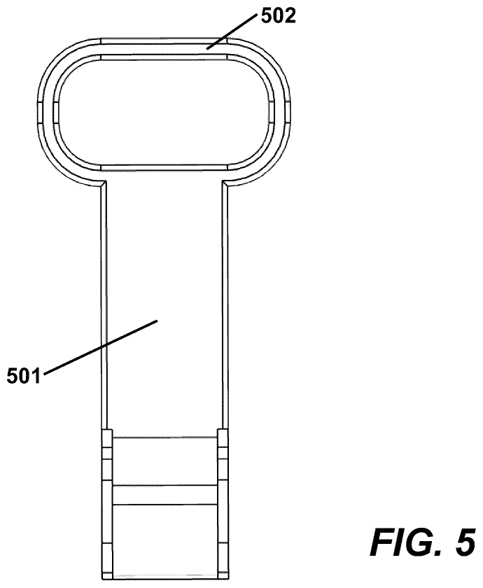

Referring to FIGS. 1 and 5, the upright member 501 defines a bottom end connected to the upper surface of base 101 and a top end opposing said bottom end, the top and bottom ends of upright member 501 being separated by an upright distance. The upright member further comprises a handle 502 located at the top end which defines an aperture configured to receive a user's hand or other similar means of holding the wheel stop device 100. The handle 502 allows a user to both position the wheel stop device 100 on the ground in a desired location without the need to bend all the way to the ground and also, in some embodiments, hold the wheel stop device 100 in place during use of the wheel stop device. The upright member 501 further serves to provide a backstop to prevent a user from pushing/pulling the cart too far past the valley section 203. To that end, embodiments of the upright member 501 are comprised of a sufficiently resilient material such that the wheel will not damage the upright member 501, such as but not limited to those rigid materials discussed herein.

In some embodiments, the upright member 501 can extend such that the upright distance is adjustable, thereby allowing a user to more easily reach the handle 502 when the wheel stop member 100 is positioned on the ground. In some such embodiments, the adjustable upright distance is a function of the upright member 501 comprising nested sections similar to a telescopic pole. In some embodiments, the upright member is foldable, collapsable, and/or detachable from the rest of the wheel stop device for easy storage. In some embodiments, the upright member 501 further comprises a hinge mechanism located substantially near the end point of engagement surface 204, which allows the upright member to fold in towards the track 201 for more efficient storage of the wheel stop device 100. In some such embodiments, the hinge mechanism is configured to lock in place when the wheel stop device 100 is in use.

The components of the wheel stop device 100 described herein are, in various embodiments, comprised of various resilient materials which can withstand the forces applied to them during the use of the wheel stop device 100 described herein. In some embodiments, the components of the wheel stop device 100 are made of a consistent material. In some embodiments, the different components of the wheel stop device 100 are made of different materials consistent with the different purposes for each component described herein. In some embodiments, the wheel stop device 100 is comprised of a non-slip, resilient material which simultaneously ensures the resilience of the wheel stop device 100 as well as holding the device in place relative to the location it is placed on the ground by a user and the user's foot, as such materials are known in the art.

In further embodiments of the present invention, the wheel stop device is adapted for use with larger and/or smaller wheels, such as but not limited to industrial wheels, wheels for non-standard shopping carts, or wheels for flatbed carts. In further yet embodiments, the wheel stop device is adapted for use as a stopper for wheels of children's toys. Many children's toys with wheels do not have locks on them, such as scooters, bicycles, riding toy cars, and skateboards, to name a few. The present invention can be utilized by parents, retail establishments, schools, day cares, etc. to secure wheeled toys in a stable and/or stationary position. Embodiments of the present invention include wheel stop devices for any item with wheels which lack an effective lock or stopper mechanism. Therefore, although the embodiments depicted and described herein refer to a wheel of a standard shopping cart, it will be appreciated that this in no way limits the scope of the wheel stop device, and embodiments of the wheel stop device are configured to achieve the purposes described herein with the wheels of a plurality of other similar items with wheels and no effective lock or stopper mechanism, as are readily known in the art, that a user desires to retain in a stable, stationary position.

The present invention also includes a method of using a wheel stop device with the components and functionality described herein to hold a wheel of a wheeled object, such as but not limited to a shopping cart, in a stable and/or stationary position. The method includes at least placing the wheel stop device 100 on the ground and rolling a wheel of a wheeled object onto the wheel stop device track 201 at the front end towards the back end until it passes over the ramp section 202 and peak 210 and settles into the valley section 203 of the track 201. In some embodiments, the method includes the valley section retaining the wheel on the valley section and thereby retaining the wheeled object in a stable position. In some embodiments, the method further comprises applying a force to a gripping surface 702 of a foot extension 701 while rolling the shopping cart wheel onto the wheel stop device 100 to hold the device in place on the ground.

In some embodiments, the method includes the upright member 501 acting as a stopper and/or preventing the wheel being driven or directed past the back end of the valley section 203. In some embodiments, the method further includes first and second wheel guards 206a, 206b preventing the wheel from moving laterally off of the track 201.

In some embodiments, placing the wheel stop device on the ground comprises holding the wheel stop device 100 by the handle 502. In some embodiments, the method further comprises holding the wheel stop device 100 in place using the handle 502 while rolling the wheel onto the wheel stop device 100. In some embodiments, placing the wheel stop device 100 on the ground further comprises adjusting the upright member 501 by extending the upright length. In some embodiments, placing the wheel stop device 100 on the ground further comprises unfolding the upright member 501 by rotating it about a hinge mechanism until the upright member 501 is approximately perpendicular to base 101.

In some embodiments, the method further comprises removing the wheel of the wheeled object off of the wheel stop device 100 by rolling the wheel out of the valley section 203 of the track 201, over the peak 210, down the ramp section 202, and off of the wheel stop device 100 through the front end. In some embodiments, the method further comprises adjusting the upright member 501 by reducing the upright length. In some embodiments, the method further comprises folding the upright member 501 over a hinge mechanism towards the track 201. In some embodiments, the method further comprises storing the wheel stop mechanism 100 in a suitable location.

In this description, references to “one embodiment,” “an embodiment,” or “embodiments” mean that the feature or features being referred to are included in at least one embodiment of the invention. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain terminology will be used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology will include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55-3.45, inclusive. Likewise, the phrase “about 3 millimeters (mm)” means 2.55 mm-3.45 mm, inclusive. When temperature is used to denote change, the term “about” means a range of values including and within 15% above and below the named value. For example, “about 5° C.,” when used to denote a change such as in “a thermal resolution of better than 5° C. across 3 mm,” means within 15% of 5° C., or 4.25° C.-5.75° C. When referring to nominal temperature, such as “about −50° C. to about +50° C.,” the term “about” means ±5° C. Thus, for example, the phrase “about 37° C.” means 32° C.-42° C.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is:

1. A wheel stop device comprising:
a base defining opposing front and back ends, a bottom surface, and an upper surface opposing said bottom surface;
a track connected to said upper surface, the track defining a ramp section and a valley section with a peak between said ramp section and said valley section;
wherein said bottom surface is configured for positioning on a ground surface;
wherein said track is configured for engagement with a wheel of a wheeled object so as to allow a user to direct the wheel up said ramp section over said peak and onto said valley section; and
wherein said valley section is configured to retain the wheel on said valley section so as to retain the wheeled object in a stable position.

2. The wheel stop device of claim 1, further comprising:
an upright member connected to said valley section at a back end of said valley section opposite said ramp section; and
wherein said upright member extends substantially upwardly away from said base.

3. The wheel stop device of claim 2, wherein:
said upright member further comprises a handle at an upper portion of said upright member.

4. The wheel stop device of claim 1, further comprising:
a foot extension near said back end of said base configured for engagement with a foot of the user.

5. The wheel stop device of claim 1, wherein:
said foot extension extends angularly relative to said base so as to provide for ergonomic engagement with the foot of the user.

6. The wheel stop device of claim 4, wherein:
said foot extension comprises a gripping surface configured to restrict the movement of the foot of the user.

7. The wheel stop device in claim 6, wherein:
said gripping surface comprises a plurality of gripping members extending outwardly from said foot extension.

8. The wheel stop device of claim 1, wherein:
said track comprises an engagement surface configured to support the wheel as the wheel rolls between said ramp section and said valley section.

9. The wheel stop device of claim 1, wherein:
said valley section defines a concave arched contour so as to retain the wheel when the wheel is positioned on said valley section until the user selectively forces the wheel off of said valley section and over said peak onto said ramp section.

10. The wheel stop device of claim 1, further comprising:
a first wheel guard positioned on a first side of said track; and
a second wheel guard positioned on a second side of said track.

11. The wheel stop device of claim 10, wherein:
said first and second wheel guards are configured to prevent the wheel from moving laterally off of said track when the user moves the wheel along said track.

12. A wheel stop device comprising:
a base defining opposing front and back ends, a bottom surface, and an upper surface opposing said bottom surface;
a track connected to said upper surface, the track defining a ramp section and a valley section with a peak between said ramp section and said valley section;
an upright member connected to said valley section at a back end of said valley section opposite said ramp section;
wherein said upright member comprises a handle at an upper portion of said upright member and extends substantially upwardly away from said base;
a foot extension near said back end of said base configured for engagement with a foot of a user;
wherein said bottom surface is configured for positioning on a ground surface;
wherein said track is configured for engagement with a wheel of a wheeled object so as to allow the user to direct the wheel up said ramp section over said peak and onto said valley section; and
wherein said valley section is configured to retain the wheel on said valley section so as to retain the wheeled option in a stable position.

13. A method of retaining a wheel of a wheeled object in a stable position, the method comprising:
providing a wheel stop device having a base defining opposing front and back ends, a bottom surface, and an upper surface opposing said bottom surface and a track connected to said upper surface, the track defining a ramp section and a valley section with a peak between said ramp section and said valley section;
placing said base of said wheel stop device on a ground surface;
directing the wheel onto the track, up the ramp section, over the peak, and onto the peak section; and
said valley section retaining the wheel on said valley section and thereby retaining the wheeled object in a stable position.

14. The method of claim 13, wherein:
said wheel stop device further comprises an upright member connected to said valley section at a back end of said valley section opposite said ramp section;
wherein said upright member extends substantially upwardly away from said base.

15. The method of claim 14, further comprising:
said upright member preventing direction of the wheel past said back end of said valley section.

16. The method of claim 13, wherein:
said wheel stop device further comprises a foot extension near said back end of said base.

17. The method of claim 16, further comprising:
placing a foot of a user on said foot extension thereby holding said wheel stop device in place on the ground surface.

18. The method of claim 13, wherein:
said wheel stop device further comprises a first wheel guard positioned on a first side of said track and a second wheel guard positioned on a second side of said track.

19. The method of claim 18, further comprising:
said first and second wheel guards preventing the wheel from moving laterally off of said track

20. The method of claim 13, wherein:
the wheeled object comprises a shopping cart.
